(19) United States
(12) Patent Application Publication
(10) Pub. No.: US 2026/0189739 A1
(43) Pub. Date: Jul. 2, 2026

(54) VIDEO TRANSMISSION METHOD AND APPARATUS, AND DEVICE AND STORAGE MEDIUM

(71) Applicant: DOUYIN VISION CO., LTD., Shijingshan District, Beijing (CN)

(72) Inventors: Haiping Wang, Beijing (CN); Zhenhua Yu, Beijing (CN); Shu Shi, Los Angeles, CA (US)

(21) Appl. No.: 19/130,268

(22) PCT Filed: Mar. 18, 2024
(86) PCT No.: PCT/CN2024/082304

§ 371 Date: May 15, 2025

(30) Foreign Application Priority Data
Apr. 18, 2023 (CN) 202310416371.7

(51) Int. Cl. H04N 21/2383; H04N 21/2385; H04N 21/845

(52) U.S. Cl. CPC H04N 21/2383; H04N 21/2385; H04N 21/8456

(57) ABSTRACT

Embodiments of the present disclosure provide a video transmission method and apparatus, a device, and a storage medium. The method includes: acquiring a first video stream and at least two target network channels; performing stream splitting processing on the first video stream to determine a second video stream corresponding to each target network channel; performing video encoding on the second video stream corresponding to each target network channel to determine an encoded third video stream corresponding to each target network channel; performing cross-channel allocation and redundancy encoding on each third video stream to determine a target redundant data stream corresponding to each target network channel; and transmitting the corresponding third video stream and the target redundant data stream through each target network channel.

### CROSS-REFERENCE TO RELATED APPLICATION(S)

This application claims priority to Chinese Inventive Patent Application No. 202310416371.7, entitled “VIDEO TRANSMISSION METHOD AND APPARATUS, AND DEVICE AND STORAGE MEDIUM”, and filed on Apr. 18, 2023, the disclosure of which is incorporated herein by reference in its entirety.

### FIELD

Embodiments of the present disclosure relate to the Internet technology, and in particular, to a video transmission method and apparatus, a device, and a storage medium.

### BACKGROUND

With the rapid development of Internet technology, the video transmission process can be affected by network fluctuations, such as delay or losses in data packet transmission. Currently, the common practice is to retransmit a lost data packet after a packet loss occurs. However, the method results in long video transmission time and may still fail in transmission under the poor network quality, making it ineffective in ensuring the success rate of video transmission.

### SUMMARY

The present disclosure provides a video transmission method and apparatus, a device, and a storage medium, for performing video transmission using at least two network channels, and effectively improving a success rate of video transmission without increasing network bandwidth costs.

In a first aspect, an embodiment of the present disclosure provides a video transmission method, including:
acquiring a first video stream and at least two target network channels;
performing stream splitting processing on the first video stream to determine a second video stream corresponding to each target network channel;
performing video encoding on the second video stream corresponding to each target network channel to determine an encoded third video stream corresponding to each target network channel;
performing cross-channel allocation and redundancy encoding on each third video stream to determine a target redundant data stream corresponding to each target network channel; and
transmitting the corresponding third video stream and the target redundant data stream through each target network channel.

In a second aspect, an embodiment of the present disclosure further provides a video transmission apparatus, including:
an information acquiring module, configured to acquire a first video stream and at least two target network channels;
a stream splitting processing module, configured to perform stream splitting processing on the first video stream to determine a second video stream corresponding to each target network channel;
a video stream encoding module, configured to perform video encoding on the second video stream corresponding to each target network channel to determine an encoded third video stream corresponding to each target network channel;
a redundant data stream determination module, configured to perform cross-channel allocation and redundancy encoding on each third video stream to determine a target redundant data stream corresponding to each target network channel; and
a video stream transmission module, configured to transmit the corresponding third video stream and the target redundant data stream through each target network channel.

In a third aspect, an embodiment of the present disclosure further provides an electronic device. The electronic device includes:
one or more processors; and
a storage apparatus, configured to store one or more programs, where
the one or more programs, when executed by the one or more processors, cause the one or more processors to implement the video transmission method according to any one of the embodiments of the present disclosure.

In a fourth aspect, an embodiment of the present disclosure further provides a storage medium including computer-executable instructions. The computer-executable instructions, when executed by a computer processor, are used to perform the video transmission method according to any one of the embodiments of the present disclosure.

According to the embodiments of the present disclosure, by performing stream splitting processing on the first video stream, the second video stream corresponding to each target network channel is determined, with a data volume of the split second video stream being less than that of the first video stream. Video encoding is performed on each second video stream, the encoded third video stream corresponding to each target network channel is determined, and cross-channel allocation and redundancy encoding are performed on each third video stream to determine the target redundant data stream corresponding to each target network channel. The corresponding third video stream and the corresponding target redundant data stream are transmitted through each target network channel, thereby using the at least two target network channels to simultaneously transmit video data. The video data transmitted by each target network channel is a part of the first video stream and the cross-channel allocated target redundant data stream, which does not increase the network bandwidth costs. When the network quality of one network channel is poor, the video stream may be recovered by using the redundant data stream sent by other network channels, thereby effectively increasing the success rate of video transmission without retransmission and also increasing the efficiency of video transmission.

### BRIEF DESCRIPTION OF THE DRAWINGS

The above and other features, advantages, and aspects of various embodiments of the present disclosure will become more apparent with reference to the accompanying drawings and the following specific implementations. Throughout the accompanying drawings, the same or similar reference numerals denote the same or similar elements. It should be understood that the accompanying drawings are illustrative, and components and elements may not necessarily be drawn to scale.

FIG. 1 is a schematic flowchart of a video transmission method according to an embodiment of the present disclosure;

FIG. 2 is an example of video stream encoding according to an embodiment of the present disclosure;

FIG. 3 is a schematic flowchart of a video transmission method according to an embodiment of the present disclosure;

FIG. 4 is a schematic flowchart of a video transmission method according to an embodiment of the present disclosure;

FIG. 5 is an example of a working process of a sending terminal according to an embodiment of the present disclosure;

FIG. 6 is a schematic flowchart of a video transmission method according to an embodiment of the present disclosure;

FIG. 7 is an example of a working process of a receiving terminal according to an embodiment of the present disclosure;

FIG. 8 is an example of determining a target video stream by a receiving terminal according to an embodiment of the present disclosure;

FIG. 9 is a schematic diagram of a structure of a video transmission apparatus according to an embodiment of the present disclosure; and

FIG. 10 is a schematic diagram of a structure of an electronic device according to an embodiment of the present disclosure.

### DETAILED DESCRIPTION OF EMBODIMENTS

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

It should be understood that the steps recorded in the method implementations of the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are open-ended inclusions, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the order or relation of interdependence of functions performed by these apparatuses, modules, or units.

It should be noted that the modifiers “one” and “a plurality of” mentioned in the present disclosure are illustrative and not limiting, and those skilled in the art should understand that unless otherwise explicitly specified in the context, the modifiers should be understood as “one or more”.

The names of messages or information exchanged between a plurality of apparatuses in the implementations of the present disclosure are used for illustrative purposes only, and are not used to limit the scope of these messages or information.

It should be understood that before the use of the technical solutions disclosed in the embodiments of the present disclosure, a user shall be informed of the type, range of use, use scenarios, etc., of personal information involved in the present disclosure in an appropriate manner in accordance with relevant laws and regulations, and the authorization of the user shall be obtained.

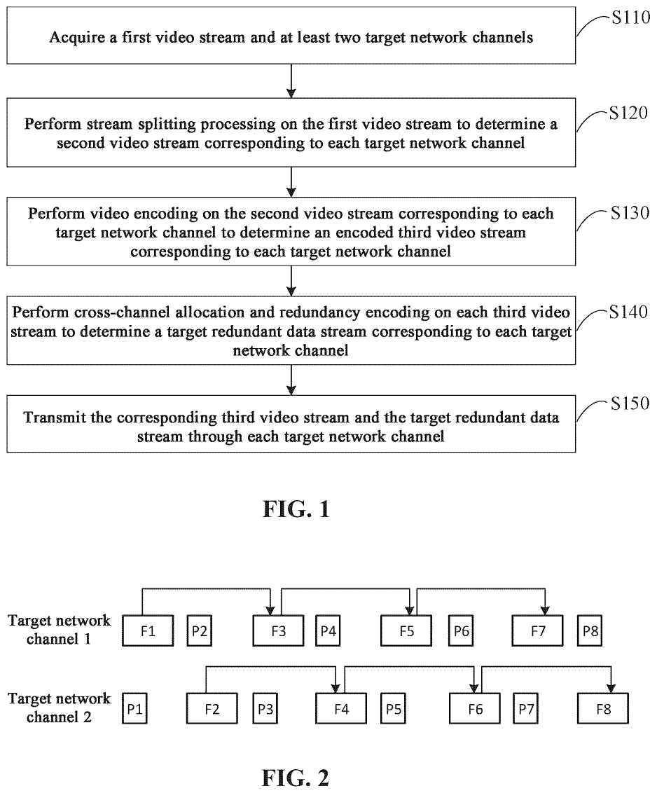

FIG. 1 is a schematic flowchart of a video transmission method according to an embodiment of the present disclosure. This embodiment of the present disclosure is applicable to a case of encoding and transmitting a generated video stream, particularly suitable for a transmission scenario requiring low delay, such as a video-on-demand scenario, a live video streaming scenario, or a video download scenario. The method may be performed by a video transmission apparatus. The apparatus may be implemented in the form of software and/or hardware, and is optionally implemented through an electronic device. The electronic device may be a sending terminal for video transmission.

As shown in FIG. 1, the video transmission method specifically includes the following steps:
S110: Acquire a first video stream and at least two target network channels.

The first video stream may refer to an original video stream generated by a video source. The first video stream is composed of a plurality of video frames. The target network channel may be a network transmission channel for video data transmission. There are at least two target network channels, and therefore the at least two target network channels are used to simultaneously transmit video data. For example, a Wifi network or a 4G network has two network channels.

Specifically, the sending terminal may acquire a pre-generated first video stream or a first video stream generated in real time from the video source, thereby performing real-time transmission on the first video stream generated in real time. The at least two target network channels are obtained based on a currently used transmission network. For example, each network channel in the currently used transmission network may be used as the target network channel, so that all network channels in the transmission network are used to perform video transmission.
S120: Perform stream splitting processing on the first video stream to determine a second video stream corresponding to each target network channel.

The second video stream may include some video frames from the first video stream. The target network channels are in one-to-one correspondence with the second video streams.

Specifically, the sending terminal may perform stream splitting processing on the first video stream based on a preset stream splitting method and a video frame rate corresponding to the first video stream. For example, each video frame in the first video stream may be round-robin allocated to each target network channel, to obtain the second video stream corresponding to each target network channel. It should be noted that all the second video streams corresponding to all the target network channels may also be merged into the first video stream.

Exemplarily, S120 may include: determining a target frame rate corresponding to each target network channel based on the video frame rate corresponding to the first video stream; and based on the target frame rate, round-robin allocation is performed on the video frames of the first video stream to determine the second video stream corresponding to each target network channel.

The video frame rate corresponding to the first video stream is an original video frame rate. The target frame rate corresponding to each target network channel refers to a video frame rate of the second video stream corresponding to each target network channel. Since the second video stream is a substream of the first video stream, the target frame rate corresponding to each target network channel is less than the video frame rate corresponding to the first video stream.

Specifically, the corresponding same or different target frame rates may be set for each target network channel based on business requirements, and each target frame rate is less than the video frame rate corresponding to the first video stream. For example, the video frame rate corresponding to the first video stream may be divided by the number of the target network channels, and an obtained division result may be used as the target frame rate corresponding to each target network channel to facilitate equal stream splitting of the first video stream. Each video frame in the first video stream is round-robin allocated to each target network channel according to the target frame rate corresponding to each target network channel and an allocation sequence of the target network channels, to obtain the second video stream corresponding to each target network channel.

For example, if the first video stream is {a video frame F1, a video frame F2, a video frame F3, a video frame F4, a video frame F5, a video frame F6, a video frame F7, a video frame F8, . . . }, and there are two target network channels with each having a corresponding target frame rate that is half of the video frame rate corresponding to the first video stream, after round-robin allocation, the second video stream corresponding to the target network channel 1 is {the video frame F1, the video frame F3, the video frame F5, the video frame F7, . . . }, and the second video stream corresponding to the target network channel 2 is {the video frame F2, the video frame F4, the video frame F6, the video frame F8, . . . }.
S130: Perform video encoding on the second video stream corresponding to each target network channel to determine an encoded third video stream corresponding to each target network channel.

The third video stream may refer to a video encoded stream obtained after encoding the second video stream. The third video stream is composed of a plurality of encoded frames. For example, the encoded frames may include key frames (i.e., I frames), forward predictive encoded frames (i.e., P frames), or bidirectional predictive encoded frames (i.e., B frames). The I frames are decoded only using information of the key frames without reference to other video frames. There is a longer interval between two I frames. The P frames need to be decoded with reference to information of video frames before a current frame, and the phenomenon of screen distortion may be caused if the referred video frames get lost. The B frames need to be decoded with reference to video frames before and after the current frame, and the phenomenon of screen distortion may also be caused if the referred video frames get lost.

Specifically, a video encoder may be arranged in each target network channel, and encoding parameters in each video encoder are configured. For each target network channel, the sending terminal may input the second video stream corresponding to the target network channel to the corresponding video encoder, the video encoder performs video encoding based on the configured encoding parameters, and outputs the encoded third video stream, to obtain the third video stream corresponding to the target network channel. By independently encoding the second video stream corresponding to each target network channel, the independently encoded third video stream is obtained, thereby subsequently allowing a receiving terminal to also independently decode the received third video stream.

For example, FIG. 2 illustrates a video stream encoding example. As shown in FIG. 2, independent encoding is performed in the order of the video frames in the second video stream corresponding to the target network channel 1: {the video frame F1, the video frame F3, the video frame F5, the video frame F7, . . . }. For example, the video frame F3 is encoded only based on the video frame F1 rather than the video frame F2 in the target network channel 2, thereby achieving independent encoding of the second video stream.
S140: Perform cross-channel allocation and redundancy encoding on each third video stream to determine a target redundant data stream corresponding to each target network channel.

The cross-channel allocation may refer to allocation of the third video stream corresponding to each target network channel to other target network channels. Namely, the third video stream allocated to each target network channel is not the original third video stream corresponding to itself. For example, if the target network channel 1 corresponds to the third video stream 1 and the target network channel 2 corresponds to the third video stream 2, after cross-channel allocation, the target network channel 1 corresponds to the third video stream 2, and the target network channel 2 corresponds to the third video stream 1.

Redundancy encoding may refer to encoding the allocated third video stream based on a redundant technology. The redundancy encoding method may be, but is not limited to, forward error correction (FEC) encoding. The target redundant data stream may refer to redundant protection data of the allocated third video stream, thereby recovering the corresponding third video stream based on the target redundant data stream.

Specifically, the sending terminal may perform cross-channel allocation on the third video stream corresponding to each target network channel and then perform redundancy encoding on the allocated third video stream to obtain the target redundant data stream corresponding to each target network channel. Alternatively, redundancy encoding may be first performed on the third video stream corresponding to each target network channel to obtain an original redundant data stream corresponding to each target network channel, and then cross-channel allocation is performed on each original redundant data stream to obtain the target redundant data stream corresponding to each target network channel. This embodiment does not limit the order of cross-channel allocation and redundancy encoding.

For example, as shown in FIG. 2, after the second video stream corresponding to the target network channel 1 is encoded, the obtained third video stream is {an encoded frame F1, an encoded frame F3, an encoded frame F5, an encoded frame F7, . . . }, and correspondingly, the third video stream corresponding to the target network channel 2 is {an encoded frame F2, an encoded frame F4, an encoded frame F6, an encoded frame F8, . . . }. After cross-channel allocation, the third video stream corresponding to the target network channel 1 is: {the encoded frame F2, the encoded frame F4, the encoded frame F6, the encoded frame F8, . . . }, and redundancy encoding is performed on each encoded frame in the third video stream to obtain the target redundant data stream corresponding to the target network channel 1: {a redundant encoded frame P2, a redundant encoded frame P4, a redundant encoded frame P6, a redundant encoded frame P8, . . . }. Similarly, the target redundant data stream corresponding to the target network channel 2 is: {a redundant encoded frame P1, a redundant encoded frame P3, a redundant encoded frame P5, a redundant encoded frame P7, . . . }.
S150: Transmit the corresponding third video stream and the target redundant data stream through each target network channel.

Specifically, the sending terminal and the receiving terminal are connected through each target network channel. The sending terminal may transmit the third video stream and the target redundant data stream corresponding to each target network channel to the receiving terminal through each target network channel. For example, as shown in FIG. 2, the target network channel 1 transmits the corresponding third video stream {the encoded frame F1, the encoded frame F3, the encoded frame F5, the encoded frame F7, . . . } and the target redundant data stream {the redundant encoded frame P2, the redundant encoded frame P4, the redundant encoded frame P6, the redundant encoded frame P8, . . . }. The target network channel 2 transmits the corresponding third video stream {the encoded frame F2, the encoded frame F4, the encoded frame F6, the encoded frame F8, . . . } and the target redundant data stream {the redundant encoded frame P1, the redundant encoded frame P3, the redundant encoded frame P5, the redundant encoded frame P7, . . . }. By sending the third video stream {the encoded frame F1, the encoded frame F3, the encoded frame F5, the encoded frame F7, . . . } and the original redundant data stream {the redundant encoded frame P1, the redundant encoded frame P3, the redundant encoded frame P5, the redundant encoded frame P7, . . . } corresponding to the third video stream through different target network channels, when there is something wrong in one target network channel, such as the loss of the third video stream, the original redundant data stream corresponding to the third video stream transmitted through the other target network channel may be used to rapidly recover the third video stream, and cross-path transmission does not occupy the network bandwidth of weak network channels, thereby improving a success rate of video transmission.

It should be noted that if the first video stream and the corresponding redundant data stream are directly transmitted, the bandwidth costs may be increased. Through stream splitting and cross-path transmission, the success rate of video transmission may be increased without increasing the bandwidth costs.

Exemplarily, the corresponding third video stream and the corresponding target redundant data stream may be synchronously transmitted through each target network channel, so that the third video stream and the original redundant data stream corresponding to the third video stream may be simultaneously received through different target network channels, thereby recovering the third video stream in time based on the original redundant data stream corresponding to the third video stream, and then ensuring the low delay.

According to the technical solution in this embodiment of the present disclosure, by performing stream splitting processing on the first video stream, the second video stream corresponding to each target network channel is determined, with a data volume of the split second video stream being less than that of the first video stream. Video encoding is performed on each second video stream, the encoded third video stream corresponding to each target network channel is determined, and cross-channel allocation and redundancy encoding are performed on each third video stream to determine the target redundant data stream corresponding to each target network channel. The corresponding third video stream and the corresponding target redundant data stream are transmitted through each target network channel, thereby using the at least two target network channels to simultaneously transmit the video data. The video data transmitted by each target network channel is a part of the first video stream and the cross-channel allocated target redundant data stream, which does not increase the network bandwidth costs. When the network quality of one network channel is poor, the video stream may be recovered by using the redundant data stream sent by other network channels, thereby effectively increasing the success rate of video transmission without retransmission and also increasing the efficiency of video transmission.

Based on the above technical solution, the step S110 of “acquiring at least two target network channels” may include: acquiring a network delay duration corresponding to each candidate network channel; determining a maximum delay difference between two network channels based on the video frame rate corresponding to the first video stream; and determining a target network channel from the plurality of candidate network channels based on the network delay duration and the maximum delay difference.

The candidate network channel refers to a network channel that may be used for data transmission. For example, each network channel contained in a currently used transmission network may be used as the candidate network channel. The network delay duration may refer to a delay duration for data transmission through the candidate network channel. The maximum delay difference may refer to an allowed maximum delay difference between two network channels. The target network channel may refer to an available network channel that ensures low delay.

Specifically, the sending terminal may perform detection to obtain the network delay duration of each candidate network channel. An interval duration between two adjacent frames is determined based on the video frame rate corresponding to the first video stream, and twice the interval duration may be determined as maximum allowed delay information to ensure the low delay. A network delay difference between every two candidate network channels may be determined based on the network delay duration of each candidate network channel, namely, a difference value between the network delay durations corresponding to the two candidate network channels. The network delay difference between every two candidate network channels is compared with the maximum delay difference, the target network channel is determined from all the candidate network channels, and the determined network delay difference between any two target network channels is less than or equal to the maximum delay difference, thereby ensuring the low delay of video transmission. Alternatively, the two candidate network channels with the minimum network delay difference as the target network channels, thereby using the optimal two target network channels to perform ultralow-delay transmission.

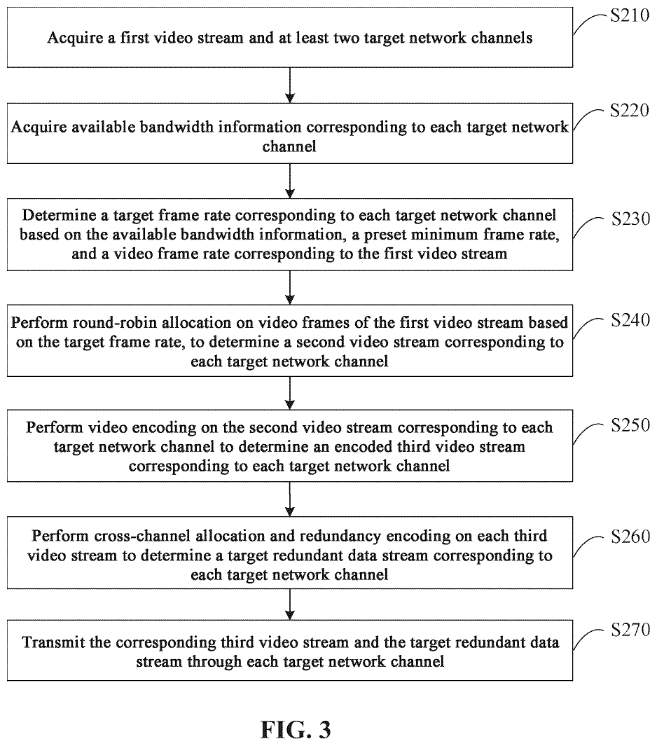

FIG. 3 is a schematic flowchart of a video transmission method according to an embodiment of the present disclosure. Based on the above disclosed embodiment, this embodiment of the present disclosure optimizes the step of “determining a target frame rate corresponding to each target network channel based on the video frame rate corresponding to the first video stream”. Terms that are the same with or correspond to those in the above disclosed embodiment are not repeated herein.

As shown in FIG. 3, the video transmission method specifically includes the following steps:
S210: Acquire a first video stream and at least two target network channels.
S220: Acquire available bandwidth information corresponding to each target network channel.

Specifically, a sending terminal may perform detection to obtain the available bandwidth information corresponding to each target network channel. The available bandwidth information may be used to represent the volume of data that can be transmitted per second by the target network channel.
S230: Determine a target frame rate corresponding to each target network channel based on the available bandwidth information, a preset minimum frame rate, and a video frame rate corresponding to the first video stream.

The preset minimum frame rate may be a minimum frame rate pre-determined based on fluency requirements. The target frame rate corresponding to each target network channel is greater than or equal to the preset minimum frame rate, to ensure fluency experience during the display of low-frame-rate videos. The video frame rate corresponding to the first video stream is a maximum frame rate corresponding to each target network channel. The target frame rate corresponding to each target network channel is less than the video frame rate corresponding to the first video stream.

Specifically, the sending terminal may determine an available frame rate range based on the preset minimum frame rate and the video frame rate corresponding to the first video stream, and select, based on the available bandwidth information corresponding to each target network channel, an optimal frame rate with the highest image quality as the corresponding target frame rate within the available frame rate range.

Exemplarily, S230 may include: determining a single-frame size range allowed for transmission by each target network channel based on the available bandwidth information, the preset minimum frame rate, and the video frame rate corresponding to the first video stream; and determining a maximum single-frame size allowed for transmission by each target network channel based on the single-frame size range, and determining the target frame rate corresponding to each target network channel based on the maximum single-frame size and the available bandwidth information.

The single-frame size may refer to a data volume of a single video frame. The single-frame size range may be composed of a minimum value of single-frame size and a maximum value of single-frame size. The minimum value of single-frame size may refer to a minimum data volume of a single video frame. The minimum value of single-frame size may refer to a maximum data volume of a single video frame. The single-frame size may be used to represent the image quality of a video frame. For example, the larger the single-frame size, the higher the image quality of the video frame.

Specifically, the minimum value of single-frame size allowed for transmission by each target network channel may be determined based on the available bandwidth information corresponding to each target network channel and the preset minimum frame rate. The minimum value of single-frame size allowed for transmission by each target network channel may be determined based on the available bandwidth information corresponding to each target network channel and the video frame rate corresponding to the first video stream, thereby obtaining the single-frame size range allowed for transmission by each target network channel. The single-frame size range allowed for transmission by each target network channel is compared, to determine the maximum single-frame size allowed for transmission by each target network channel, namely the common maximum single-frame size for all the target network channels. The available bandwidth information corresponding to each target network channel is divided by the maximum single-frame size, and an obtained division result is used as the target frame rate corresponding to each target network channel. An optimal frame rate allocation result under the highest image quality may be determined using the available bandwidth information corresponding to each target network channel, thereby ensuring the image quality of video transmission by the plurality of target network channels.

Exemplarily, the determining a single-frame size range allowed for transmission by each target network channel based on the available bandwidth information, the preset minimum frame rate, and the video frame rate corresponding to the first video stream may include:
dividing current available bandwidth information corresponding to a current target network channel by the preset minimum frame rate to obtain the minimum value of single-frame size allowed for transmission by the current target network channel; and dividing the current available bandwidth information corresponding to the current target network channel by the video frame rate corresponding to the first video stream, to obtain the minimum value of single-frame size allowed for transmission by the current target network channel.

Specifically, each target network channel may be used as the current target network channel, and the single-frame size range allowed for transmission by each target network channel is determined through the above steps.
S240: Perform round-robin allocation on video frames of the first video stream based on the target frame rate, to determine a second video stream corresponding to each target network channel.

Specifically, round-robin allocation may be performed on each video frame in the first video stream based on the target frame rate corresponding to each target network channel, to obtain the second video stream with the target frame rate corresponding to each target network channel.

For example, if there are two target network channels, the target frame rate corresponding to the target network channel 1 may be divided by the target frame rate corresponding to the target network channel 2 to obtain a frame rate multiple, and equal round-robin allocation is performed on each video frame in the first video stream according to the frame rate multiple. For example, if the frame rate multiple is 2, the first video stream is {a video frame F1, a video frame F2, a video frame F3, a video frame F4, a video frame F5, a video frame F6, a video frame F7, a video frame F8, . . . }, and after round-robin allocation, the second video stream corresponding to the target network channel 1 is {the video frame F1, the video frame F2, the video stream F4, the video frame F5, the video frame F7, the video frame F8 . . . }, and the second video stream corresponding to the target network channel 2 is {the video frame F3, the video frame F6, . . . }.
S250: Perform video encoding on the second video stream corresponding to each target network channel to determine an encoded third video stream corresponding to each target network channel.

Specifically, the sending terminal may respectively configure frame rate parameters and code rate parameters in a video encoder based on the target frame rate and available bandwidth corresponding to each target network channel, to allow the video encoder in each target network channel to perform encoding according to a configured frame rate and a configured code rate. To ensure the consistent image quality in all the target network channels, the video encoder in each target network channel may be configured with the same quantization parameter (QP) and a size of a group of pictures (GOP).

It should be noted that the sending terminal may periodically and continuously detect available bandwidth information and network delay information of each target network channel. If there is a significant change in a test result compared to a current stage, a target network bandwidth is re-determined based on the currently measured network delay information, a target frame rate corresponding to each target network channel is re-determined based on the currently measured available bandwidth information, and encoding parameters in the video encoder are updated to better conform to a current network condition, thereby further ensuring the success rate and the image quality of video transmission.
S260: Perform cross-channel allocation and redundancy encoding on each third video stream to determine a target redundant data stream corresponding to each target network channel.
S270: Transmit the corresponding third video stream and the target redundant data stream through each target network channel.

According to the technical solution in this embodiment of the present disclosure, the target frame rate that adapts to the available bandwidth and has the highest image quality may be determined based on the available bandwidth information corresponding to each target network channel, the preset minimum frame rate, and the video frame rate corresponding to the first video frame, thereby further improving the success rate and a video display effect of video transmission.

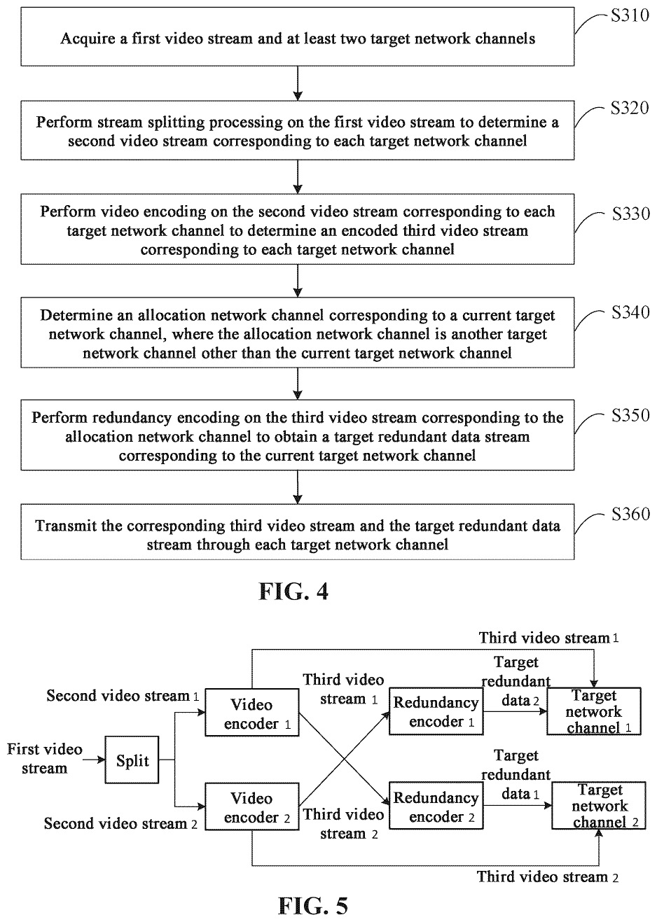

FIG. 4 is a schematic flowchart of a video transmission method according to an embodiment of the present disclosure. Based on the above disclosed embodiment, this embodiment of the present disclosure optimizes the step of “performing cross-channel allocation and redundancy encoding on each third video stream to determine a target redundant data stream corresponding to each target network channel”. Terms that are the same with or correspond to those in the above disclosed embodiment are not repeated herein.

As shown in FIG. 4, the video transmission method specifically includes the following steps:
S310: Acquire a first video stream and at least two target network channels.
S320: Perform stream splitting processing on the first video stream to determine a second video stream corresponding to each target network channel.
S330: Perform video encoding on the second video stream corresponding to each target network channel to determine an encoded third video stream corresponding to each target network channel.
S340: Determine an allocation network channel corresponding to the current target network channel, where the allocation network channel is another target network channel other than the current target network channel.

Specifically, each target network channel may be used as the current target network channel, and a target redundant data stream corresponding to each target network channel is determined by performing steps S340 and S350. For example, a cross-channel sending allocation relationship may be pre-established based on a practical scenario and business requirements, thereby determining the allocation network channel corresponding to the current target network channel based on the pre-established cross-channel sending allocation relationship For example, if there are two target network channels, the cross-channel sending allocation relationship is as follows: the target network channel 1 corresponds to the target network channel 2, the target network channel 2 corresponds to the target network channel 1, and when the current target network channel is the target network channel 1, the corresponding allocation network channel is the target network channel 2, thereby achieving crossed cross-channel allocation.

For another example, if there are at least three target network channels, the allocation network channel corresponding to the current target network channel may refer to all other target network channels other than the current target network channel, thereby allowing the current target network channel to transmit redundant data of a third video stream corresponding to all other target network channels. Alternatively, the allocation network channel corresponding to the current target network channel may refer to one other target network channel other than the current target network channel, so that the current target network channel only transmits a redundant data stream of a third video stream corresponding to one other target network channel, thereby saving network bandwidth. In this case, it is necessary to ensure that there is one other target network channel for transmitting the redundant data stream of the third video stream corresponding to each target network channel, thereby ensuring cross-path transmission of the redundant data stream of each third video stream. For example, if there are three target network channels, the cross-channel sending allocation relationship is as follows: the target network channel 1 corresponds to the target network channel 2, the target network channel 2 corresponds to the target network channel 3, the target network channel 3 corresponds to the target network channel 1, and when the current target network channel is the target network channel 2, the corresponding allocation network channel is the target network channel 3, thereby achieving single cross-channel allocation and further saving network bandwidth.
S350: Perform redundancy encoding on the third video stream corresponding to the allocation network channel to obtain a target redundant data stream corresponding to the current target network channel.

Specifically, an I-frame redundancy proportion and a P-frame redundancy proportion may be preset based on content importance. Redundancy encoding, such as FEC encoding is performed on the third video stream corresponding to the allocation network channel based on the I-frame redundancy proportion and the P-frame redundancy proportion, and the obtained redundant data stream is used as the target redundant data stream corresponding to the current target network channel. For example, the I-frame redundancy proportion is set to 10%, and the P-frame redundancy proportion is set to 5%, thereby generating 10% of redundant data for all I frames in the third video stream corresponding to the allocation network channel, and 5% of redundant data for P frames. If the volume of the redundant data of the P frame is insufficient to fill a packet (e.g., 1024 KB), a plurality of consecutive P frames may be combined to generate redundant data, thereby providing stronger protection for the I frame with higher importance.
S360: Transmit the corresponding third video stream and the target redundant data stream through each target network channel.

Exemplarily, FIG. 5 illustrates an example of a working process of the sending terminal. As shown in FIG. 5, the sending terminal corresponds to two target network channels, and each target network channel corresponds to one video encoder and one redundancy encoder. After the sending terminal splits a first video stream, an obtained second video stream 1 and an obtained second video stream 2 are respectively input to the video encoder 1 and the video encoder 2 to be subjected to video encoding, thereby obtaining a third video stream 1 and a third video stream 2. The third video stream 1 is input to the redundancy encoder 2 corresponding to the target network channel 2 to be subjected to redundancy encoding, thereby obtaining an original redundant data stream corresponding to the third video stream 1, namely a target redundant data stream 1. Similarly, the third video stream 2 is input to the redundancy encoder 1 corresponding to the target network channel 1 to be subjected to redundancy encoding, thereby obtaining an original redundant data stream corresponding to the third video stream 2, namely a target redundant data stream 1. The third video stream 1 and the target redundant data stream 2 are transmitted through the target network channel 1, and the third video stream 2 and the target redundant data stream 1 are transmitted through the target network channel 2, so that the third video streams and the corresponding original redundant data streams may be transmitted through different network channels, and then when there is something wrong in the third video stream sent by a certain target network channel, the third video stream may be rapidly recovered directly through the redundant data stream sent through the other target network channel, thereby improving the success rate and efficiency of data transmission.

According to the technical solution in this embodiment of the present disclosure, the allocation network channel corresponding to the current target network channel is determined, where the allocation network channel is another target network channel other than the current target network channel; and redundancy encoding is performed on the third video stream corresponding to the allocation network channel to obtain the target redundant data stream corresponding to the current target network channel, thereby transmitting the third video stream and the corresponding original redundant data stream through different network channels, and then effectively improving the success rate and efficiency of data transmission.

Based on the above technical solution, S350 may include: acquiring a current packet loss rate corresponding to the current target network channel; determining a redundant data proportion corresponding to a single video frame based on the current packet loss rate; and performing redundancy encoding on the third video stream corresponding to the allocation network channel based on the redundant data proportion to obtain the target redundant data stream corresponding to the current target network channel.

Specifically, the sending terminal may perform detection to obtain the current packet loss rate corresponding to the current target network channel, and determine the current packet loss rate as the redundant data proportion corresponding to the single video frame. Redundancy encoding may be performed on the third video stream corresponding to the allocation network channel based on the redundant data proportion, and then the target redundant data stream under the redundant data proportion is obtained. For example, forward error correction encoding may be performed on the third video stream corresponding to the allocation network channel based on the redundant data proportion, and an obtained encoded data stream is used as the target redundant data stream corresponding to the current target network channel.

Exemplarily, if a data volume of the target redundant data stream is greater than a remaining available bandwidth corresponding to the current target network channel, a redundant data proportion corresponding to the remaining available bandwidth may be determined, and redundancy encoding is performed based on the redundant data proportion, so that the data volume of the target redundant data stream obtained after redundancy encoding is equal to the remaining available bandwidth corresponding to the current target network channel, thereby dynamically adapting to the current network bandwidth, and further ensuring the success rate of target redundant data stream transmission.

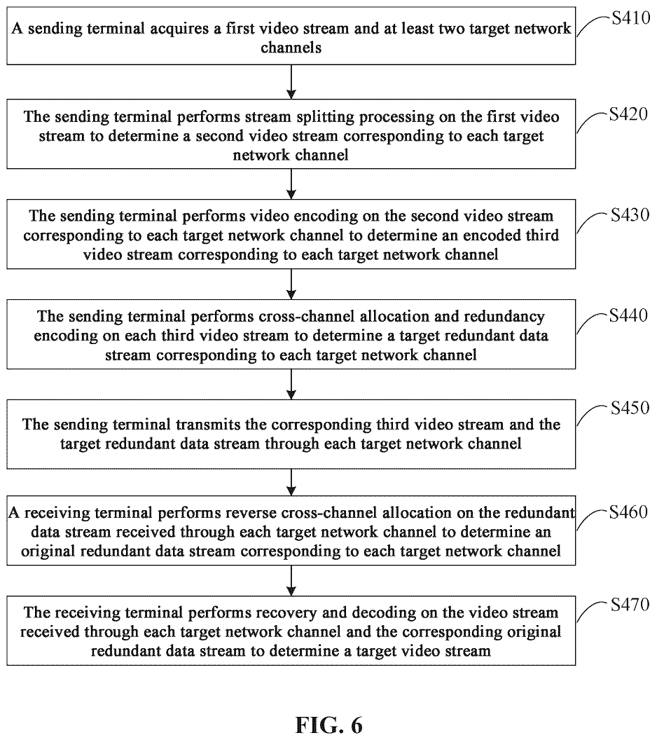

FIG. 6 is a schematic flowchart of a video transmission method according to an embodiment of the present disclosure. Based on the above disclosed embodiment, this embodiment of the present disclosure provides a detailed description of the process that a receiving terminal determines a target video stream based on a video stream and a redundant data stream received through each target network channel. Terms that are the same with or correspond to those in the above disclosed embodiment are not repeated herein.

As shown in FIG. 6, the video transmission method specifically includes the following steps:
S410: A sending terminal acquires a first video stream and at least two target network channels.
S420: The sending terminal performs stream splitting processing on the first video stream to determine a second video stream corresponding to each target network channel.
S430: The sending terminal performs video encoding on the second video stream corresponding to each target network channel to determine an encoded third video stream corresponding to each target network channel.
S440: The sending terminal performs cross-channel allocation and redundancy encoding on each third video stream to determine a target redundant data stream corresponding to each target network channel.
S450: The sending terminal transmits the corresponding third video stream and the target redundant data stream through each target network channel.
S460: The receiving terminal performs reverse cross-channel allocation on the redundant data stream received through each target network channel to determine an original redundant data stream corresponding to each target network channel.

The video stream received through each target network channel may be the complete third video stream or part of the third video stream sent by each target network channel. The redundant data stream received through each target network channel may be the complete target redundant data stream or part of the target redundant data stream sent by each target network channel. The original redundant data stream corresponding to the target network channel may refer to a redundant data stream of the video stream sent by the target network channel.

Specifically, a cross-channel receiving allocation relationship may be pre-established, and the cross-channel receiving allocation relationship and the cross-channel sending allocation relationship are opposite correspondences. The receiving terminal may perform, based on the pre-established cross-channel receiving allocation relationship, reverse cross-channel allocation on the redundant data stream received through each target network channel to obtain the original redundant data stream corresponding to each target network channel. For example, if the cross-channel sending allocation relationship is as follows: a target network channel 1 corresponds to a target network channel 2, the target network channel 2 corresponds to a target network channel 3, and the target network channel 3 corresponds to the target network channel 1, the corresponding cross-channel receiving allocation relationship is as follows: the target network channel 1 corresponds to the target network channel 3, the target network channel 2 corresponds to the target network channel 1, and the target network channel 3 corresponds to the target network channel 2. Based on the cross-channel receiving allocation relationship, the redundant data stream received by the target network channel 1 may be determined as the original redundant data stream corresponding to the target network channel 3.The redundant data stream received by the target network channel 2 is determined as the original redundant data stream corresponding to the target network channel 1.The redundant data stream received by the target network channel 3 is determined as the original redundant data stream corresponding to the target network channel 2.

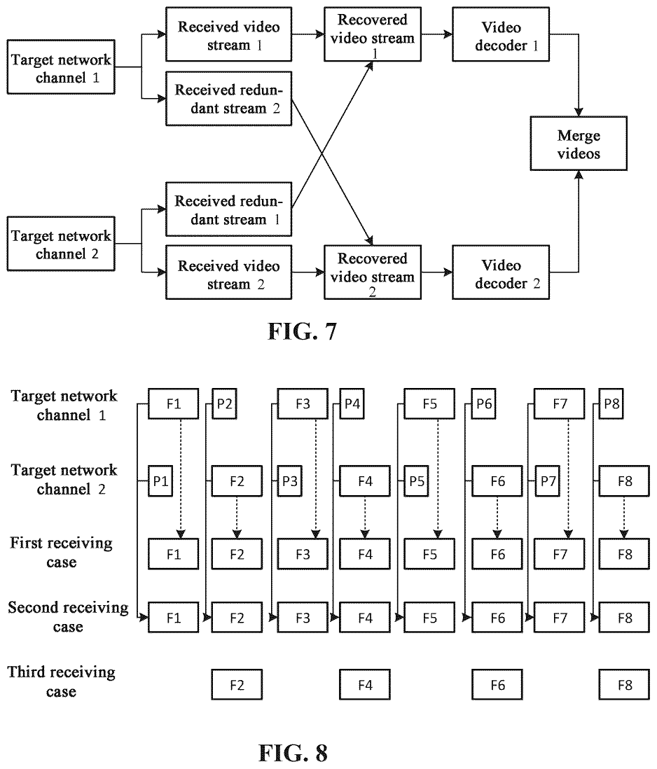

For example, FIG. 7 illustrates an example of a working process of the receiving terminal. A receiving process in FIG. 7 corresponds to a sending process in FIG. 5.As shown in FIG. 7, a redundant data stream 2 received by a target network channel 1 may be used as an original redundant data stream 2 corresponding to a target network channel 2, and a redundant data stream 1 received by the target network channel 2 is used as an original redundant data stream 1 corresponding to the target network channel 1.
S470: The receiving terminal performs recovery and decoding on the video stream received through each target network channel and the corresponding original redundant data stream to determine a target video stream.

The target video stream may refer to a video stream that is finally received by the receiving terminal. The target video stream may be a first video stream, or a first video stream with a low frame rate, such as a second video stream.

Specifically, as shown in FIG. 7, the receiving terminal performs recovery and decoding on the video stream 1 and the corresponding original redundant data stream 1 received by the target network channel to obtain the second video stream 1 corresponding to the target network channel 1. Similarly, the second video stream 2 corresponding to the target network channel 2 is received, and the first video stream 1 and the second video stream 2 may be merged according to a preset merging method matched with a preset stream splitting method to obtain the first video stream, namely the target video stream. The target video stream may be displayed on the receiving terminal, thereby ensuring the success rate of video transmission.

Exemplarily, S470 may include: determining the recovered third video stream based on the video stream received through each target network channel and the corresponding original redundant data stream, and decoding the third video stream to obtain the second video stream corresponding to each target network channel; and merging the second video stream corresponding to each target network channel to determine the first video stream, and using the first video stream as the target video stream.

For example, FIG. 8 illustrates an example of determining the target video stream by the receiving terminal. For a first receiving case in FIG. 8, if the receiving terminal successfully receives the complete third video stream through each target network channel, there is no need for recovery, each third video stream is directly decoded to obtain the corresponding second video stream, and all the second video streams are merged to obtain the original first video stream, thereby obtaining an original video stream with a high frame rate, as indicated by dashed arrows in FIG. 8.For a second receiving case in FIG. 8, if the receiving terminal fails in receiving the complete third video stream through each target network channel, the third video stream may be recovered based on the received part of third video stream and the corresponding original redundant data stream, the recovered third video stream is decoded to obtain the corresponding second video stream, and the original first video stream is obtained through merging, thereby obtaining the original video stream with the high frame rate, as indicated by solid arrows in FIG. 8.

Exemplarily, S470 may further include: if some of target network channels recover and decode the corresponding second video streams based on the video stream received through each target network channel and the corresponding original redundant data stream, determining the target video stream based on the decoded second video streams.

Specifically, if the target network channels cannot recover the corresponding third video streams due to the poor network quality of the part of target network channels, the corresponding second video streams may be recovered and decoded based on other target network channels, to determine the target video stream. For example, for a third receiving case in FIG. 8, the target network channel 1 cannot recover the corresponding third video stream and only the target network channel 2 can recover the corresponding third video stream, in this case, the corresponding third video stream recovered by the third target network channel 2 may be directly decoded, the obtained second video stream is used as the target video stream, and therefore when the network quality is poor, an original video stream with a low frame rate may also be obtained, thereby avoiding the situation of video stuttering and ensuring smoothness.

For another example, if at least two target network channels recover and decode the corresponding second video streams, based on a frame rate corresponding to each recovered and decoded second video stream, the second video stream with the maximum frame rate is used as the target video stream, or all the recovered and decoded second video streams may be merged, and a merged video stream is used as the target video stream, thereby further improving the frame rate of the displayed video stream, ensuring video display smoothness, and then enhancing user viewing experience.

According to the technical solution in this embodiment of the present disclosure, the receiving terminal performs reverse cross-channel allocation on the redundant data stream received through each target network channel, determines the original redundant data stream corresponding to each target network channel, and recovers and decodes the video stream received through each target network channel and the corresponding original redundant data stream to determine the target video stream, thereby rapidly performing recovery and decoding, and ensuring the success rate of video transmission.

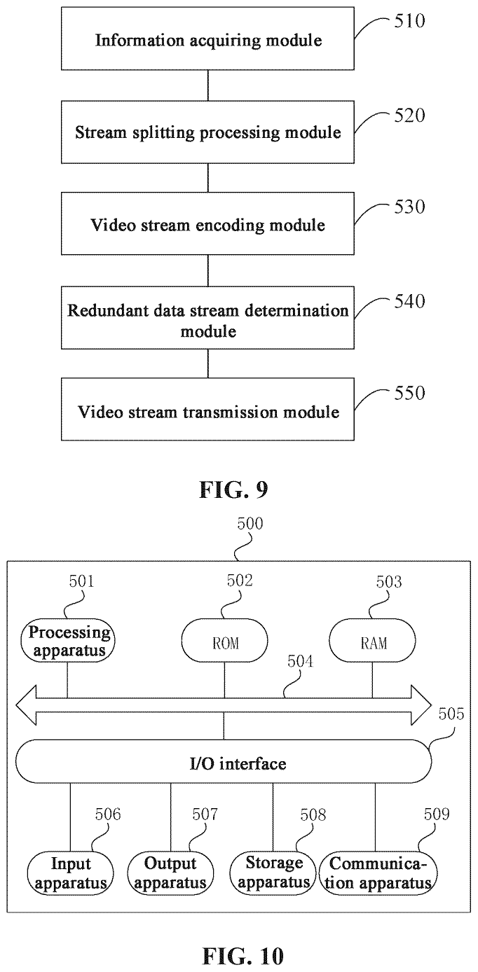

FIG. 9 is schematic diagram of a structure of a video transmission apparatus according to an embodiment of the present disclosure. As shown in FIG. 9, the apparatus specifically includes: an information acquiring module 510, a stream splitting processing module 520, a video stream encoding module 530, a redundant data stream determination module 540, and a video stream transmission module 550.

The information acquiring module 510 is configured to acquire a first video stream and at least two target network channels; the stream splitting processing module 520 is configured to perform stream splitting processing on the first video stream to determine a second video stream corresponding to each target network channel; the video stream encoding module 530 is configured to perform video encoding on the second video stream corresponding to each target network channel to determine an encoded third video stream corresponding to each target network channel; the redundant data stream determination module 540 is configured to perform cross-channel allocation and redundancy encoding on each third video stream to determine a target redundant data stream corresponding to each target network channel; and the video stream transmission module 550 is configured to transmit the corresponding third video stream and the target redundant data stream through each target network channel.

According to the technical solution in this embodiment of the present disclosure, by performing stream splitting processing on the first video stream, the second video stream corresponding to each target network channel is determined, with a data volume of the split second video stream being less than that of the first video stream. Video encoding is performed on each second video stream, the encoded third video stream corresponding to each target network channel is determined, and cross-channel allocation and redundancy encoding are performed on each third video stream to determine the target redundant data stream corresponding to each target network channel. The corresponding third video stream and the corresponding target redundant data stream are transmitted through each target network channel, thereby using the at least two target network channels to simultaneously transmit video data. The video data transmitted by each target network channel is a part of the first video stream and the cross-channel allocated target redundant data stream, which does not increase the network bandwidth costs. When the network quality of one network channel is poor, the video stream may be recovered by using the redundant data stream sent by other network channels, thereby effectively increasing the success rate of video transmission without retransmission and also increasing the efficiency of video transmission.

Based on the above technical solution, the information obtaining module 510 is specifically configured to:
acquire a network delay duration corresponding to each candidate network channel; determine a maximum delay difference between two network channels based on the video frame rate corresponding to the first video stream; and determine a target network channel from the plurality of candidate network channels based on the network delay duration and the maximum delay difference.

Based on the above various technical solutions, the stream splitting processing module 520 includes:
a target frame rate determination submodule, configured to determine a target frame rate corresponding to each target network channel based on the video frame rate corresponding to the first video stream;
a second video stream determination submodule, configured to perform, based on the target frame rate, round-robin allocation on video frames of the first video stream to determine the second video stream corresponding to each target network channel.

Based on the above various technical solutions, the target frame rate determination submodule includes:
an available bandwidth information acquiring unit, configured to acquire available bandwidth information corresponding to each target network; and
a target frame rate determination unit, configured to determine a target frame rate corresponding to each target network channel based on the available bandwidth information, a preset minimum frame rate, and the video frame rate corresponding to the first video stream.

Based on the above various technical solutions, the target frame rate determination unit includes:
a single-frame size range determination subunit, configured to determine a single-frame size range allowed for transmission by each target network channel based on the available bandwidth information, the preset minimum frame rate, and the video frame rate corresponding to the first video stream; and
a target frame rate determination subunit, configured to determine a maximum single-frame size allowed for transmission by each target network channel based on the single-frame size range, and determine a target frame rate corresponding to each target network channel based on the maximum single-frame size and the available bandwidth information.

Based on the above various technical solutions, the single-frame size range determination subunit is specifically configured to:
divide current available bandwidth information corresponding to a current target network channel by the preset minimum frame rate to obtain the minimum value of single-frame size allowed for transmission by the current target network channel; and divide the current available bandwidth information corresponding to the current target network channel by the video frame rate corresponding to the first video stream, to obtain a minimum value of single-frame size allowed for transmission by the current target network channel.

Based on the above various technical solutions, the redundant data stream determination module 540 includes:
an allocation network channel determination submodule, configured to determine an allocation network channel corresponding to the current target network channel, where the allocation network channel is another target network channel other than the current target network channel; and
a redundant data stream determination submodule, configured to perform redundancy encoding on a third video stream corresponding to the allocation network channel to obtain a target redundant data stream corresponding to the current target network channel.

Based on the above various technical solutions, the redundant data stream determination submodule includes:
a current packet loss rate acquiring unit, configured to acquire a current packet loss rate corresponding to the current target network channel;
a redundant data proportion determination unit, configured to determine a redundant data proportion corresponding to a single video frame based on the current packet loss rate; and
a redundant data stream determination unit, configured to perform redundancy encoding on the third video stream corresponding to the allocation network channel based on the redundant data proportion to obtain a target redundant data stream corresponding to the current target network channel.

Based on the above various technical solutions, the redundant data stream determination unit is specifically configured to:
perform, based on the redundant data proportion, forward error correction encoding on the third video stream corresponding to the allocation network channel, and use an obtained encoded data stream as the target redundant data stream corresponding to the current target network channel.

Based on the above various technical solutions, the apparatus further includes:
an original redundant data stream determination module, configured to perform reverse cross-channel allocation on a redundant data stream received through each target network channel to determine an original redundant data stream corresponding to each target network channel; and
a target video stream determination module, configured to recover and decode the video stream received through each target network channel and the corresponding original redundant data stream to determine the target video stream.

Based on the above various technical solutions, the target video stream determination module is specifically configured to:
determine a recovered third video stream based on the video stream received through each target network channel and the corresponding original redundant data stream, and decode the third video stream to obtain a second video stream corresponding to each target network channel; and merge the second video stream corresponding to each target network channel to determine a first video stream, and use the first video stream as the target video stream.

Based on the above various technical solutions, the target video stream determination module is further specifically configured to:
determine, in a case of some of target network channels recovering and decoding corresponding second video streams based on the video stream received through each target network channel and the corresponding original redundant data stream, a target video stream based on the decoded second video streams.

The video transmission apparatus according to this embodiment of the present disclosure may perform the video transmission method according to any embodiment of the present disclosure, and has the corresponding functional modules and beneficial effects for performing the video transmission method.

It should be noted that the various units and modules included in the above apparatus are only divided according to functional logics, but are not limited to the above division, as long as the corresponding functions can be achieved; and in addition, the specific names of the functional units are only for the convenience of distinguishing each other, and are not used to limit the scope of protection of the embodiments of the present disclosure.

FIG. 10 is a schematic diagram of a structure of an electronic device according to an embodiment of the present disclosure. Referring to FIG. 10 as below, FIG. 10 illustrates a schematic diagram of a structure of an electronic device (e.g., a terminal device or a server in FIG. 10) 500 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a portable Android device (PAD), a portable media player (PMP), and a vehicle terminal (e.g., a vehicle navigation terminal), and fixed terminals such as a digital TV and a desktop computer. The electronic device shown in FIG. 10 is merely an example, and should not impose any limitation on the function and scope of use of the embodiments of the present disclosure.

As shown in FIG. 10, the electronic device 500 may include a processing apparatus (e.g., a central processing unit and a graphics processing unit) 501, which may perform various appropriate actions and processing according to a program stored on a read-only memory (ROM) 502 or a program loaded from a storage apparatus 508 into a random access memory (RAM) 503. The RAM 503 further stores various programs and data required for the operation of the electronic device 500.The processing apparatus 501, the ROM 502, and the RAM 503 are connected to one another through a bus 504. An input/output (I/O) interface 505 is also connected to the bus 504.

Typically, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a magnetic tape and a hard drive; and a communication apparatus 509. The communication apparatus 509 may allow the electronic device 500 to be in wireless or wired communication with other devices for data exchange. Although FIG. 10 shows the electronic device 500 having various apparatuses, it should be understood that it is not required to implement or have all of the shown apparatuses. It may be an alternative to implement or have more or fewer apparatuses.

In particular, the above process described with reference to the flowcharts according to the embodiments of the present disclosure may be implemented as a computer software program. For example, an embodiment of the present disclosure includes a computer program product, which includes a computer program carried on a non-transitory computer-readable medium, where the computer program includes program code for performing the method shown in the flowchart. In this embodiment, the computer program may be downloaded and installed from the network through the communication apparatus 509, or installed from the storage apparatus 508, or installed from the ROM 502. The computer program, when executed by the processing apparatus 501, performs the above functions limited in the method according to the embodiments of the present disclosure.

The names of messages or information exchanged between a plurality of apparatuses in the implementations of the present disclosure are used for illustrative purposes only, and are not used to limit the scope of these messages or information.

The electronic device according to this embodiment of the present disclosure and the video transmission method according to the above embodiment belong to the same inventive concept, and for technical details not described in detail in this embodiment, reference may be made to the above embodiment. This embodiment and the above embodiment have the same beneficial effects.

An embodiment of the present disclosure provides a computer storage medium, having a computer program stored therein. The program, when executed by a processor, implements the video transmission method according to the above embodiment.

It should be noted that the above computer-readable medium in the present disclosure may be either a computer-readable signal medium or a computer-readable storage medium, or any combination of the two. The computer-readable storage medium may be, for example, but is not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above. In the present disclosure, the computer-readable storage medium may be any tangible medium including or storing a program, and the program may be for use by or for use in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to, an electromagnetic signal, an optical signal, or any suitable combination of the above. The computer-readable signal medium may further be any computer-readable medium other than the computer-readable storage medium. The computer-readable signal medium may send, propagate, or transmit a program for use by or for use in combination with the instruction execution system, apparatus, or device. The program code included in the computer-readable medium may be transmitted by any suitable medium, including but not limited to a wire, an optical cable, radio frequency (RF), etc., or any suitable combination of the above.

In some implementations, a client and a server may communicate using any currently known or future-developed network protocols such as a hypertext transfer protocol (HTTP), and may be interconnected with digital data communication in any form or medium (e.g., a communication network). Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The above computer-readable medium may be included in the above electronic device; or may also separately exist without being assembled in the electronic device.

The above computer-readable medium carries one or more programs. The above one or more programs, when executed by the electronic device, cause the electronic device to: acquire a first video stream and at least two target network channels; perform stream splitting processing on the first video stream to determine a second video stream corresponding to each target network channel; perform video encoding on the second video stream corresponding to each target network channel to determine an encoded third video stream corresponding to each target network channel; perform cross-channel allocation and redundancy encoding on each third video stream to determine a target redundant data stream corresponding to each target network channel; and transmit the corresponding third video stream and the target redundant data stream through each target network channel.

Computer program code for performing operations of the present disclosure may be written in one or more programming languages or a combination thereof, where the above programming languages include, but are not limited to, object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of the remote computer, the remote computer may be connected to the user computer through any kind of network, including a local area network (LAN) or a wide area network (WAN), or may be connected to an external computer (e.g., connected through the Internet with the aid of an Internet service provider).

The flowchart and the block diagram in the accompanying drawings illustrate the possibly implemented system architecture, functions, and operations of the system, the method, and the computer program product according to various embodiments of the present disclosure. In this regard, each block in the flowchart or the block diagram may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented using a dedicated hardware-based system that performs specified functions or operations, or may be implemented using a combination of dedicated hardware and computer instructions.

The involved units described in the embodiments of the present disclosure may be implemented through software or hardware. The name of the unit does not constitute a limitation on the unit itself in some cases. For example, a first acquiring unit may also be described as “a unit for acquiring at least two Internet protocol addresses”.

Herein, the functions described above may be at least partially executed by one or more hardware logic components. For example, without limitation, exemplary hardware logic components that can be used include: a field-programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may include or store a program for use by or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above content.

According to one or more embodiments of the present disclosure, [Example 1] provides a video transmission method, including:
acquiring a first video stream and at least two target network channels;
performing stream splitting processing on the first video stream to determine a second video stream corresponding to each target network channel;
performing video encoding on the second video stream corresponding to each target network channel to determine an encoded third video stream corresponding to each target network channel;
performing cross-channel allocation and redundancy encoding on each third video stream to determine a target redundant data stream corresponding to each target network channel; and
transmitting the corresponding third video stream and the target redundant data stream through each target network channel.

According to one or more embodiments of the present disclosure, [Example 2] provides a video transmission method, further including:
optionally, the acquiring at least two target network channels including:
acquiring a network delay duration corresponding to each candidate network channel;
determining a maximum delay difference between two network channels based on a video frame rate corresponding to the first video stream; and
determining a target network channel from the plurality of candidate network channels based on the network delay duration and the maximum delay difference.

According to one or more embodiments of the present disclosure, [Example 3] provides a video transmission method, further including:
optionally, the performing stream splitting processing on the first video stream to determine a second video stream corresponding to each target network channel including:
determining a target frame rate corresponding to each target network channel based on the video frame rate corresponding to the first video stream; and
performing, based on the target frame rate, round-robin allocation on video frames of the first video stream to determine the second video stream corresponding to each target network channel.

According to one or more embodiments of the present disclosure, [Example 4] provides a video transmission method, further including:
optionally, the determining a target frame rate corresponding to each target network channel based on the video frame rate corresponding to the first video stream including:
acquiring available bandwidth information corresponding to each target network channel; and
determining the target frame rate corresponding to each target network channel based on the available bandwidth information, a preset minimum frame rate, and the video frame rate corresponding to the first video stream.

According to one or more embodiments of the present disclosure, [Example 5] provides a video transmission method, further including:
optionally, the determining the target frame rate corresponding to each target network channel based on the available bandwidth information, a preset minimum frame rate, and the video frame rate corresponding to the first video stream including:
determining a single-frame size range allowed for transmission by each target network channel based on the available bandwidth information, the preset minimum frame rate, and the video frame rate corresponding to the first video stream; and
determining a maximum single-frame size allowed for transmission by each target network channel based on the single-frame size range, and determining the target frame rate corresponding to each target network channel based on the maximum single-frame size and the available bandwidth information.

According to one or more embodiments of the present disclosure, [Example 6] provides a video transmission method, further including:
optionally, the determining a single-frame size range allowed for transmission by each target network channel based on the available bandwidth information, the preset minimum frame rate, and the video frame rate corresponding to the first video stream including:
dividing current available bandwidth information corresponding to a current target network channel by the preset minimum frame rate to obtain a minimum value of single-frame size allowed for transmission by the current target network channel; and
dividing the current available bandwidth information corresponding to the current target network channel by the video frame rate corresponding to the first video stream, to obtain a minimum value of single-frame size allowed for transmission by the current target network channel.

According to one or more embodiments of the present disclosure, [Example 7] provides a video transmission method, further including:
optionally, the performing cross-channel allocation and redundancy encoding on each third video stream to determine a target redundant data stream corresponding to each target network channel including:
determining an allocation network channel corresponding to a current target network channel, where the allocation network channel is another target network channel other than the current target network channel; and
performing redundancy encoding on a third video stream corresponding to the allocation network channel to obtain a target redundant data stream corresponding to the current target network channel.

According to one or more embodiments of the present disclosure, [Example 8] provides a video transmission method, further including:
optionally, the performing redundancy encoding on a third video stream corresponding to the allocation network channel to obtain a target redundant data stream corresponding to the current target network channel including:
acquiring a current packet loss rate corresponding to the current target network channel;
determining a redundant data proportion corresponding to a single video frame based on the current packet loss rate; and
performing redundancy encoding on the third video stream corresponding to the allocation network channel based on the redundant data proportion to obtain a target redundant data stream corresponding to the current target network channel.

According to one or more embodiments of the present disclosure, [Example 9] provides a video transmission method, further including:
optionally, the performing redundancy encoding on the third video stream corresponding to the allocation network channel based on the redundant data proportion to obtain a target redundant data stream corresponding to the current target network channel including:
performing, based on the redundant data proportion, forward error correction encoding on the third video stream corresponding to the allocation network channel, and using an obtained encoded data stream as the target redundant data stream corresponding to the current target network channel.

According to one or more embodiments of the present disclosure, [Example 10] provides a video transmission method, further including:
optionally, after the transmitting the corresponding third video stream and the target redundant data stream through each target network channel, the method further including:
performing reverse cross-channel allocation on a redundant data stream received through each target network channel to determine an original redundant data stream corresponding to each target network channel; and
performing recovery and decoding on the video stream received through each target network channel and the corresponding original redundant data stream to determine a target video stream.

According to one or more embodiments of the present disclosure, [Example 11] provides a video transmission method, further including:
optionally, the performing recovery and decoding on the video stream received through each target network channel and the corresponding original redundant data stream to determine a target video stream including:
determining a recovered third video stream based on the video stream received through each target network channel and the corresponding original redundant data stream, and decoding the third video stream to obtain a second video stream corresponding to each target network channel; and
merging the second video stream corresponding to each target network channel to determine a first video stream, and using the first video stream as the target video stream.

According to one or more embodiments of the present disclosure, [Example 12] provides a video transmission method, further including:
optionally, the performing recovery and decoding on the video stream received through each target network channel and the corresponding original redundant data stream to determine a target video stream further including:
determining, in a case of some of target network channels recovering and decoding corresponding second video streams based on the video stream received through each target network channel and the corresponding original redundant data stream, the target video stream based on the decoded second video streams.

According to one or more embodiments of the present disclosure, [Example 13] provides a video transmission apparatus, including:
an information acquiring module, configured to acquire a first video stream and at least two target network channels;
a stream splitting processing module, configured to perform stream splitting processing on the first video stream to determine a second video stream corresponding to each target network channel;
a video stream encoding module, configured to perform video encoding on the second video stream corresponding to each target network channel to determine an encoded third video stream corresponding to each target network channel;
a redundant data stream determination module, configured to perform cross-channel allocation and redundancy encoding on each third video stream to determine a target redundant data stream corresponding to each target network channel; and
a video stream transmission module, configured to transmit the corresponding third video stream and the target redundant data stream through each target network channel.

What are described above are only preferred embodiments of the present disclosure and explanations of the technical principles applied. Those skilled in the art should understand that the scope of the disclosure involved in the present disclosure is not limited to the technical solutions formed by specific combinations of the above technical features, and shall also cover other technical solutions formed by any combination of the above technical features or equivalent features thereof without departing from the above concept of disclosure, such as a technical solution formed by replacing the above features with the technical features with similar functions disclosed (but not limited to) in the present disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the present disclosure. Some features that are described in the context of separate embodiments may also be implemented in combination in a single embodiment. In contrast, various features described in the context of a single embodiment may also be implemented in a plurality of embodiments individually or in any suitable subcombination.

Although the subject matter has been described in a language specific to structural features and/or logic actions of the method, it should be understood that the subject matter defined in the appended claims is not necessarily limited to the specific features or actions described above. On the contrary, the specific features and the actions described above are merely example forms for implementing the claims.

1. A video transmission method, comprising:
acquiring a first video stream and at least two target network channels;
performing stream splitting processing on the first video stream to determine a second video stream corresponding to each target network channel;
performing video encoding on the second video stream corresponding to each target network channel to determine an encoded third video stream corresponding to each target network channel;
performing cross-channel allocation and redundancy encoding on each third video stream to determine a target redundant data stream corresponding to each target network channel; and
transmitting the corresponding third video stream and the target redundant data stream through each target network channel.

2. The video transmission method according to claim 1, wherein acquiring the at least two target network channels comprises:
acquiring a network delay duration corresponding to each candidate network channel;
determining a maximum delay difference between two network channels based on a video frame rate corresponding to the first video stream; and
determining a target network channel from a plurality of candidate network channels based on the network delay duration and the maximum delay difference.

3. The video transmission method according to claim 1, wherein performing stream splitting processing on the first video stream to determine the second video stream corresponding to each target network channel comprises:
determining a target frame rate corresponding to each target network channel based on a video frame rate corresponding to the first video stream; and
performing, based on the target frame rate, round-robin allocation of video frames on the first video stream to determine the second video stream corresponding to each target network channel.

4. The video transmission method according to claim 3, wherein determining the target frame rate corresponding to each target network channel based on the video frame rate corresponding to the first video stream comprises:
acquiring available bandwidth information corresponding to each target network channel; and
determining the target frame rate corresponding to each target network channel based on the available bandwidth information, a preset minimum frame rate, and the video frame rate corresponding to the first video stream.

5. The video transmission method according to claim 4, wherein determining the target frame rate corresponding to each target network channel based on the available bandwidth information, the preset minimum frame rate, and the video frame rate corresponding to the first video stream comprises:
determining a single-frame size range allowed for transmission by each target network channel based on the available bandwidth information, the preset minimum frame rate, and the video frame rate corresponding to the first video stream; and
determining a maximum single-frame size allowed for transmission by each target network channel based on the single-frame size range, and determining the target frame rate corresponding to each target network channel based on the maximum single-frame size and the available bandwidth information.

6. The video transmission method according to claim 5, wherein determining the single-frame size range allowed for transmission by each target network channel based on the available bandwidth information, the preset minimum frame rate, and the video frame rate corresponding to the first video stream comprises:
dividing current available bandwidth information corresponding to a current target network channel by the preset minimum frame rate to obtain a maximum value of single-frame size allowed for transmission by the current target network channel; and
dividing the current available bandwidth information corresponding to the current target network channel by the video frame rate corresponding to the first video stream, to obtain a minimum value of single-frame size allowed for transmission by the current target network channel.

7. The video transmission method according to claim 1, wherein performing cross-channel allocation and redundancy encoding on each third video stream to determine the target redundant data stream corresponding to each target network channel comprises:
determining an allocation network channel corresponding to a current target network channel, wherein the allocation network channel is another target network channel other than the current target network channel; and
performing redundancy encoding on a third video stream corresponding to the allocation network channel to obtain the target redundant data stream corresponding to the current target network channel.

8. The video transmission method according to claim 7, wherein performing redundancy encoding on a third video stream corresponding to the allocation network channel to obtain the target redundant data stream corresponding to the current target network channel comprises:
acquiring a current packet loss rate corresponding to the current target network channel;
determining a redundant data proportion corresponding to a single video frame based on the current packet loss rate; and
performing redundancy encoding on the third video stream corresponding to the allocation network channel based on the redundant data proportion to obtain a target redundant data stream corresponding to the current target network channel.

9. The video transmission method according to claim 8, wherein performing redundancy encoding on the third video stream corresponding to the allocation network channel based on the redundant data proportion to obtain the target redundant data stream corresponding to the current target network channel comprises:
performing, based on the redundant data proportion, forward error correction encoding on the third video stream corresponding to the allocation network channel to obtain an encoded data stream as the target redundant data stream corresponding to the current target network channel.

10. The video transmission method according to claim 1, wherein after transmitting the corresponding third video stream and the target redundant data stream through each target network channel, the method further comprises:
performing reverse cross-channel allocation on a redundant data stream received through each target network channel to determine an original redundant data stream corresponding to each target network channel; and
performing recovery and decoding on the video stream received through each target network channel and the corresponding original redundant data stream to determine a target video stream.

11. The video transmission method according to claim 10, wherein performing recovery and decoding on the video stream received through each target network channel and the corresponding original redundant data stream to determine the target video stream comprises:
determining a recovered third video stream based on the video stream received through each target network channel and the corresponding original redundant data stream, and decoding the third video stream to obtain a second video stream corresponding to each target network channel; and
merging the second video stream corresponding to each target network channel to determine a first video stream, and using the first video stream as the target video stream.

12. The video transmission method according to claim 10, wherein performing recovery and decoding on the video stream received through each target network channel and the corresponding original redundant data stream to determine the target video stream comprises:
determining, in response to a portion of target network channels recovering and decoding corresponding second video streams based on the video stream received through each target network channel and the corresponding original redundant data stream, the target video stream based on the decoded second video streams.

13. (canceled)

14. An electronic device, comprising:
one or more processors; and
a storage apparatus, configured to store one or more programs, wherein
the one or more programs, when executed by the one or more processors, cause the one or more processors to:
acquire a first video stream and at least two target network channels;
perform stream splitting processing on the first video stream to determine a second video stream corresponding to each target network channel;
perform video encoding on the second video stream corresponding to each target network channel to determine an encoded third video stream corresponding to each target network channel;
perform cross-channel allocation and redundancy encoding on each third video stream to determine a target redundant data stream corresponding to each target network channel; and
transmit the corresponding third video stream and the target redundant data stream through each target network channel.

15. A non-transitory storage medium comprising computer-executable instructions, wherein the computer-executable instructions, when executed by a computer processor, are configured to:
acquire a first video stream and at least two target network channels;
perform stream splitting processing on the first video stream to determine a second video stream corresponding to each target network channel;
perform video encoding on the second video stream corresponding to each target network channel to determine an encoded third video stream corresponding to each target network channel;
perform cross-channel allocation and redundancy encoding on each third video stream to determine a target redundant data stream corresponding to each target network channel; and
transmit the corresponding third video stream and the target redundant data stream through each target network channel.

16. The electronic device according to claim 14, wherein the one or more programs causing the one or more processors to acquire the at least two target network channels further cause the one or more processors to:
acquire a network delay duration corresponding to each candidate network channel;
determine a maximum delay difference between two network channels based on a video frame rate corresponding to the first video stream; and
determine a target network channel from a plurality of candidate network channels based on the network delay duration and the maximum delay difference.

17. The electronic device according to claim 14, wherein the one or more programs causing the one or more processors to perform stream splitting processing on the first video stream to determine the second video stream corresponding to each target network channel further cause the one or more processors to:
determine a target frame rate corresponding to each target network channel based on a video frame rate corresponding to the first video stream; and
perform, based on the target frame rate, round-robin allocation of video frames on the first video stream to determine the second video stream corresponding to each target network channel.

18. The electronic device according to claim 17, wherein the one or more programs causing the one or more processors to determine the target frame rate corresponding to each target network channel based on the video frame rate corresponding to the first video stream further cause the one or more processors to:
acquire available bandwidth information corresponding to each target network channel; and
determine the target frame rate corresponding to each target network channel based on the available bandwidth information, a preset minimum frame rate, and the video frame rate corresponding to the first video stream.

19. The electronic device according to claim 18, wherein the one or more programs causing the one or more processors to determine the target frame rate corresponding to each target network channel based on the available bandwidth information, the preset minimum frame rate, and the video frame rate corresponding to the first video stream further cause the one or more processors to:
determine a single-frame size range allowed for transmission by each target network channel based on the available bandwidth information, the preset minimum frame rate, and the video frame rate corresponding to the first video stream; and
determine a maximum single-frame size allowed for transmission by each target network channel based on the single-frame size range, and determine the target frame rate corresponding to each target network channel based on the maximum single-frame size and the available bandwidth information.

20. The electronic device according to claim 19, wherein the one or more programs causing the one or more processors to determine the single-frame size range allowed for transmission by each target network channel based on the available bandwidth information, the preset minimum frame rate, and the video frame rate corresponding to the first video stream further cause the one or more processors to:
divide current available bandwidth information corresponding to a current target network channel by the preset minimum frame rate to obtain a maximum value of single-frame size allowed for transmission by the current target network channel; and
divide the current available bandwidth information corresponding to the current target network channel by the video frame rate corresponding to the first video stream, to obtain a minimum value of single-frame size allowed for transmission by the current target network channel.

21. The electronic device according to claim 14, wherein the one or more programs causing the one or more processors to perform cross-channel allocation and redundancy encoding on each third video stream to determine the target redundant data stream corresponding to each target network channel further cause the one or more processors to:
determine an allocation network channel corresponding to a current target network channel, wherein the allocation network channel is another target network channel other than the current target network channel; and
perform redundancy encoding on a third video stream corresponding to the allocation network channel to obtain the target redundant data stream corresponding to the current target network channel.
